(19) United States
(12) Patent Application Publication
(10) Pub. No.: US 2026/0135296 A1
(43) Pub. Date: May 14, 2026

(54) COMPACT ANTENNA DEVICE FOR APPLICATIONS AT HOME

(71) Applicant: PITTWAY SARL, Rolle (CH)

(72) Inventors: Bertrand Debever, Le Cannet Alpes Maritimes (FR); Michal Pokorny, Rolle (CH)

(73) Assignee: PITTWAY SARL, Rolle (CH)

(21) Appl. No.: 18/872,335

(22) PCT Filed: Jun. 6, 2022
(86) PCT No.: PCT/EP2022/065305

§ 371 Date: Dec. 6, 2024

(51) Int. Cl. H01Q 5/321; H01Q 1/22; H01Q 5/335; H01Q 9/04; H04B 1/00

(52) U.S. Cl. CPC H01Q 5/321; H01Q 1/2291; H01Q 5/335; H01Q 9/0407; H04B 1/0003

(57) ABSTRACT

A compact antenna device is provided. The compact antenna device comprises: a first antenna segment configured to work at a first frequency; a second antenna segment connected to the first antenna segment by a first filter; a third antenna segment configured to work at the first frequency and connected to the second antenna segment by a second filter; a controller; a first switch configured to connect the controller to the first antenna segment or the third antenna segment, thereby selecting an antenna operating at the first frequency; a frequency selector, wherein the frequency selector together with the first and second filters are configured to enable a second operating frequency of the device; and a third filter configured to connect the first antenna segment to the first switch.

### FIELD OF THE INVENTION

The present invention relates to a compact antenna device. The dual-band antenna may be used e.g. in home appliances with loT capabilities, security control panels or thermostat control panels.

### BACKGROUND OF THE INVENTION

Dual-band equipment is adapted for wireless communication over two different bands. For example, the dual-band equipment may be adapted to provide connectivity over both the sub-GHz band (e.g. 915 MHz or 868 MHz, depending on location) and the 2.4 GHz band. Such arrangement may be advantageous for a number of reasons. For example, the sub-GHz range has longer range and lower consumption than the 2.4 GHz band and is used in many loT (internet of things) applications, while the 2.4 GHz band includes WiFi and Bluetooth protocols, among others.

At least one antenna is provided for the 2.4 GHz band. Another antenna is normally required for the sub-GHz range. However, some of the devices in which the antennae are positioned (such as security and thermostat control panels) are required to be relatively compact. The PCB (printed circuit board) on which the antennae are positioned and which is part of the respective device is also comparably small, and the space available to accommodate the antennae on the PCB is limited.

Therefore, there is a need for a compact antenna device.

### SUMMARY OF THE INVENTION

In the first aspect of the invention, a compact antenna device. The compact antenna device comprises: a first antenna segment configured to work at a first frequency; a second antenna segment connected to the first antenna segment by a first filter; a third antenna segment configured to work at the first frequency and connected to the second antenna segment by a second filter; a controller; a first switch configured to connect the controller to the first antenna segment or the third antenna segment, thereby selecting an antenna operating at the first frequency; a frequency selector, wherein the frequency selector together with the first and second filters are configured to enable a second operating frequency of the device; and a third filter configured to connect the first antenna segment to the first switch.

In the second aspect of the invention, a device such as a thermostat or a security control panel is provided, the device comprising the dual-band antenna of the first aspect.

Different embodiments of the invention are described in the appended claims and also in the detailed description below.

### BRIEF DESCRIPTION OF THE DRAWINGS

Specific embodiments of the present invention will now be described, by way of example only, with reference to the accompanying drawings in which:

FIG. 1 is a schematic view of a PCB with a compact antenna device in a first setting;

FIG. 2 is a schematic view of a PCB with a compact antenna device in a second setting;

FIG. 3 is a schematic view of a PCB with a dual-band antenna in an alternative embodiment;

FIG. 4 is a schematic view of a dual band antenna in detail.

### DETAILED DESCRIPTION

The below description and the appended drawings are for illustration purposes only, and they are not intended to be limiting. Various elements of embodiments described below may be combined as appropriate.

FIG. 1 shows a schematic view of a PCB 111 on which a compact antenna device 110 is positioned. The compact antenna device 110 is described below with reference to a dual-band antenna, which is a preferred embodiment of the compact antenna device 110. The PCB 111 is shown in a simplified way, with many of its components omitted for greater clarity.

The PCB 111 may be a part of a thermostat control panel, a security control panel or another appropriate control panel that is configured to receive input and/or send instructions to at least one other device. For example, a thermostat control panel or may receive input from at least one sensor (e.g. a temperature or humidity sensor). The thermostat control panel may send instructions to at least one device (e.g. a water heater or a HVAC system). The thermostat control panel may also communicate with (send information to and/or receive commands from) an external device such as a user's smart phone. In this setting, the sensors may operate on a sub-GHz frequency (e.g. 868 MHz or 915 MHz), while the communication with the user's smart phone may be realized over 2.4 GHz frequency.

Similarly, a security control panel may receive input from at least one sensor (a temperature or humidity sensor in case of a thermostat control panel, glass-breaking sensor, motion sensor or door-open sensor). The security control panel may communicate with (send information to and/or receive commands from) at least one remote device such as a user's smart phone or a central panel of a remote security agency. As in the example above, the sensors may operate on a sub-GHz frequency, while the communication with the user's smart phone or the remote security agency may be realized over 2.4 GHz frequency.

Other applications of the dual-band antenna 110 and the PCB 111 are possible. For example, the PCB 111 may be a part of a peripheral device. The peripheral device may be e.g. a sensor. The peripheral device may be a motion detector or a temperature sensor. The peripheral device may be a detector or sensor used in a home security or HVAC system. The peripheral device may communicate with a control panel (such as a control panel mentioned above) and/or with a user device such as mobile phone.

With appropriate adaptations to the dual-band antenna 110, other frequencies than those mentioned above may be used.

The dual-band antenna 110 is of a shape and length to operate in a sub-GHz range. For example, when operating at 868 MHz, the overall length of the antenna 110 may be 64 mm. The antenna 110 includes three segments 110a, 110b, 110c. The first segment 110a is connected to the second segment 110b through a first filter 108. The second segment 110b is connected to the third segment 110c through a second filter 109. The first and second filters 108, 109 are of the same type. The filters 108, 109 are configured to pass the sub-GHz frequency (e.g. 868 MHz) and eliminate (attenuate) a higher frequency, e.g. 2.4 GHz.

In the specific example described below, both the first and second filters 108, 109 pass the sub-GHz frequency (in this example, 868 MHz) and attenuate a higher frequency (in this example, 2.4 GHz). When the signal is in the sub-GHz range, the three antenna segments 110a-c are connected and the length of the antenna is the sum of the lengths of the three antenna segments 110a-c. The antenna 110 is thus configured to receive/transmit the sub-GHz frequency. At the same time, when working at the 2.4 GHz frequency, the antenna 110 is divided by the first and second filters 108, 109 into the three segments 110a-c. The antenna 110 may thus provide two segments 110 a, 110 c which may both operate at 2.4 GHz, independently of the antenna 110 also operating at the sub-GHz frequency.

In many applications, it is advantageous to provide two different antennae for the 2.4 GHz band between which a controller 100 may switch; this helps in addressing a fading issue (which in indoor settings may originate e.g. from multipath propagation and obstacles such as walls). When working in the 2.4 GHz range, the first and third antenna segments 110 a and 110 c are isolated from each other. Two separate 2.4 GHz antennae are thus provided by the first segment 110a and the third segment 110c respectively. Provision of two antennae for the 2.4 GHz frequency may help address the fading issues. In some configurations, the range inside a building may be doubled.

To provide the possibilities to select the appropriate range of the available ranges (i.e. whether a signal in the sub-GHz range or the 2.4 GHz range will be received/transmitted) and/or the appropriate antenna from the two 2.4 GHz antennae, the following arrangement is provided.

The PCB 111 comprises an antenna controller 100. The controller 100 comprises an antenna selector 101, a 2.4 GHz processor 102, a sub-GHz processor 103 and a band selector 104.

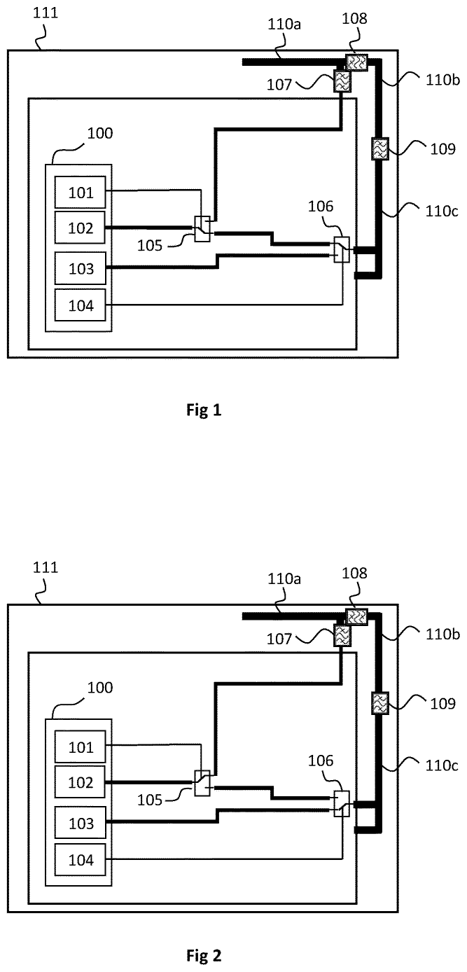

The 2.4 GHz processor 102 and the sub-GHz processor 103 process the signal received/transmitted by the antenna 110 in the 2.4 GHz or the sub-GHz configuration, respectively. The selection of the respective sub-GHz or 2.4 GHz range is achieved by the band selector 104. The band selector 104 controls a frequency selector 106, 106′. In the examples in FIGS. 1 and 2, the band selector is a switch 106. The switch 106 may be controlled by the band selector 104 to selectively connect the antenna 110 to either the sub-GHz processor 103 or the 2.4 GHz processor 102, thus selecting which signal (which frequency) will be processed. In the example of the Figures, the switch 106 connects the controller 100 to the third antenna segment 110c.

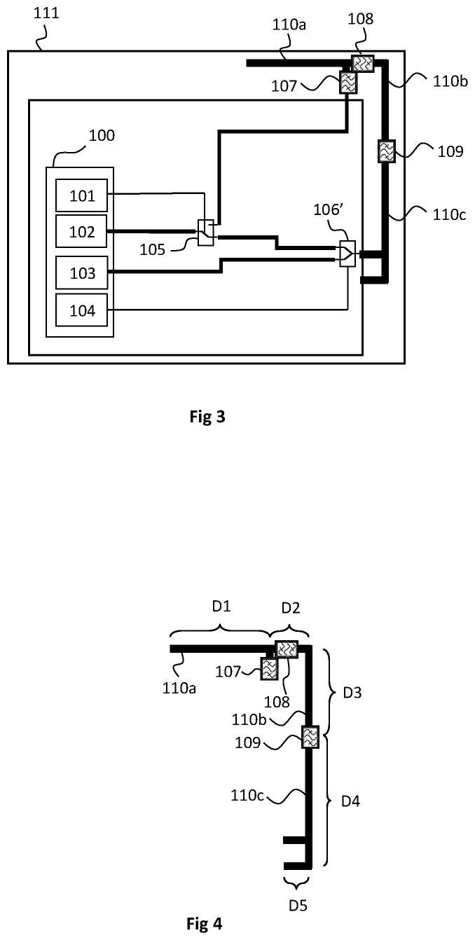

In the frequency selector 106, 106′, the switch 106 may be replaced by other suitable components, e.g. a diplexer 106′. This is shown in FIG. 3. The embodiment from FIG. 3, which employs the diplexer 106′, may be of advantage when signals of both the 2.4 GHz band and the sub-GHz band are required to be processed simultaneously by the controller 100.

In the 2.4 GHz range, both the first antenna segment 110 a and the third antenna segment 110c are capable of receiving/transmitting the signal. To select which of the first and third antenna segments 110a, c will be connected to the 2.4 GHz processor 102, an antenna selector 101 is provided. The antenna selector 101 is connected to a switch 105, which is capable of selectively connecting the first antenna segment 110a or the third antenna segment 110 c to the 2.4 GHz processor 102. This ensures that there are two antennae for the 2.4 GHZ range, thus helping to address the signal fading problems.

FIG. 1 shows one possible configuration of the antenna 110: the switch 106 is set to select the 2.4 GHz processor 102 (i.e. connect the third antenna segment 110 c to the 2.4 GHz processor) and at the same time the switch 105, which selects between the first antenna segment 110a and the third antenna segment 110c is set to select the third antenna segment 110 c. In this configuration, signal in the 2.4 GHz band received from/transmitted by the third antenna segment 110c is being processed.

Another possible configuration of the antenna 110 (not shown in the Figs) is the switch 106 being set to select the 2.4 GHz processor 102 (i.e. connect the third antenna segment 110 c to the 2.4 GHz processor) and at the same time the switch 105, which selects between the first antenna segment 110a and the third antenna segment 110c, is set to select the first antenna segment 110 a. In this configuration, signal in the 2.4 GHz band received from/transmitted by the first antenna segment 110a is being processed. The third antenna segment 110c is not connected to the processor 100.

Another possible configuration of the antenna 110 (not shown in the Figs) is the switch 106 being set to connect the antenna 110 to the sub-GHz processor 103 and the switch 105, which selects between the first antenna segment 110a and the third antenna segment 110c, is set to select the third antenna segment 110 c. In such case, the switch 106 disconnects the 2.4 GHz processor 102 from the antenna 110, the first antenna segment 110a is not connected to the processor 110, and the sub-GHz signal is received/transmitted.

Another possible configuration of the antenna 110 (shown in FIG. 2) is the switch 106 being set to connect the antenna 110 to the sub-GHz processor 103 and the switch 105 being set to connect the first segment of the antenna 110 a to the 2.4 GHz processor 102. For such cases, a third filter 107 is provided between the first antenna segment 110 a and the 2.4 GHz processor 102. As mentioned above, the third filter 107 is configured to pass the 2.4 GHz signal and eliminate (attenuate) the sub-GHz signal.

It is to be understood that in the Figures, a specific example is shown. Components shown in the Figures may be replaced by suitable alternatives.

FIG. 4 shows a detail of the antenna 110. The lengths D1 to D5 may be as follows: D1=18 mm, D2=10 mm, D3=15 mm, D4=21 mm, D5=7 mm. These lengths correspond to frequencies of 2.4 GHz and 868 MHz (as the sub-GHz frequency) respectively.

Generally, the antenna described above may be adapted to work in different frequencies than those stated above. For example, depending on local regulations, the sub-GHz frequency may be any frequency between 700 MHz and 999 GHz (even more generally, the sub-GHz may be any frequency below 1 GHz), and the length of the antenna may be easily adapted accordingly. Similarly, the 2.4 GHz antennae may be replaced by e.g. 5 GHz antennae, and the length of the first and third antenna segments may be easily adapted accordingly.

1. A compact antenna device comprising:
a first antenna segment configured to work at a first frequency;
a second antenna segment connected to the first antenna segment by a first filter;
a third antenna segment configured to work at the first frequency and connected to the second antenna segment by a second filter;
a controller;
a first switch configured to connect the controller to the first antenna segment or the third antenna segment, thereby selecting an antenna operating at the first frequency;
a frequency selector, wherein the frequency selector together with the first and second filters are configured to enable a second operating frequency of the compact antenna device; and
a third filter configured to connect the first antenna segment to the first switch.

2. The compact antenna device of claim 1, wherein the first frequency is 2.4 GHz.

3. The compact antenna device of claim 1, wherein the second frequency is 868 MHz or 915 MHz.

4. The compact antenna device of claim 1, wherein the frequency selector is a switch.

5. The dual-band antenna of claim 1, wherein the frequency selector is a diplexer.

6. The compact antenna device of claim 1, wherein the controller is configured to select the first frequency and/or the second frequency.

7. The compact antenna device of claim 1, claims, wherein the controller is configured to select the first antenna segment or the third antenna segment when working at the first frequency.

8. The compact antenna device of claim 1, wherein the first filter and the second filter attenuate the first frequency.

9. The compact antenna device of claim 1, wherein the third filter attenuates the second frequency.

10. A device comprising:
a first antenna segment configured to work at a first frequency;
a second antenna segment connected to the first antenna segment by a first filter;
a third antenna segment configured to work at the first frequency and connected to the second antenna segment by a second filter;
a controller;
a first switch configured to connect the controller to the first antenna segment or the third antenna segment, thereby selecting an antenna operating at the first frequency;
a frequency selector, wherein the frequency selector together with the first and second filters are configured to enable a second operating frequency of the device; and
a third filter configured to connect the first antenna segment to the first switch.

11. The device of claim 10, wherein the device is one of the following: a control panel, a thermostat control panel, a security control panel, a peripheral device for a home security system, a peripheral device for a HVAC system, a sensor, a detector.

12. The device of claim 10, wherein the device is a control panel configured to communicate with:
at least one first external device using the first frequency; and
at least one second external device using the second frequency.

13. The device of claim 12, wherein the at least one first external device includes a hand-held user device and/or a central security panel.

14. The device of claim 12, wherein the at least one second external device includes a sensor and/or an internet-of-things-capable device.

15. The device of claim 10, wherein the device comprises a printed circuit board.
